(19) United States
(12) Patent Application Publication
(10) Pub. No.: US 2006/0282256 A1
(43) Pub. Date: Dec. 14, 2006

(54) TRANSLATION METHOD UTILIZING CORE ANCIENT ROOTS

(76) Inventor: Anna Frances Werner, St. Louis, MO (US)

Correspondence Address: BLACKWELL SANDERS PEPER MARTIN LLP, 720 OLIVE STREET, SUITE 2400, ST. LOUIS, MO, 63101, US

(21) Appl. No.: 11/423,352

(22) Filed: Jun. 9, 2006

Related U.S. Application Data
(60) Provisional application No. 60/690,110, filed on Jun. 13, 2005.

(51) Int. Cl. G06F 17/28

(52) U.S. Cl. 704/5

(57) ABSTRACT

A new method of translating, which is suggested for translations of ancient languages based upon new general rules for ancient language translation comprising the steps of: identifying every single core ancient root and associated ancient root family and correlating it to a translated single English root, with near 100% consistency, where any English word utilized for a specific ancient root family is only used once and every different ancient root uses a new English word, and where all related roots within a family derived from the same core ancient root utilize consistent English words to allow the reader to follow the core root. Another embodiment of the invention further comprises the steps of text platform created by an expert; worldwide editing; a measure of text confidence and accuracy for external reviewers on the WAN; and methodology rules for the editing process.

### CROSS REFERENCE TO RELATED APPLICATION

This application claims the benefit of U.S. provisional application Ser. No. 60/690,110, filed Jun. 13, 2005 the disclosure of which is incorporated herein by reference.

### BACKGROUND OF INVENTION

1. Field of Invention

This invention relates generally to translation methods and, more particularly, to methods of translating ancient texts.

2. Background Art

When studying modern translations of an ancient text, such as the Bible, often times the student researches the root meaning of the original manuscript's ancient language such as the root meaning of a Hebrew or Greek word. When a student performs such research, the student gains a tremendous amount of insight into the intended meaning of the ancient text. As a student matures in their understanding of the ancient text they can find, however, that the tools that they refer to in order to glean meaning from the text are inconsistent in how a given root word is translated. Therefore, the student may find it difficult to retain knowledge concerning ancient roots because of the inconsistency in the translations.

A typical Bible translation style having study aids will provide footnotes or dictionaries relating to the text to explain the meaning of certain words by providing insight into meaning of the ancient root. However, this requires the student to pause and refer to the footnote or dictionary. Heavy footnoting is sometimes required because of the inconsistencies between different interpretations from various scholars of the ancient

Literal translations of the Bible appear to have the same problems, for example the Hendrickson's Interlinear Bible (The Interlinear Hebrew-Greek-English Bible, The Trinitarian Bible Society, London, England, 1976) and Morris' Literal Translation (The Bible Library, Ellis Enterprises, 1999). Although for most students the pure literal translation is unreadable for everyday use, many students will utilize literal translations to gain insight. Hendrickson's for example is improved, but literal translations noted above lack a matching concordance, and have many translating inconsistencies like their non-literal translation counterparts.

Many translations utilize the original Strong's numbering system, which arguably has many errors. (The original Strong's numbering system was a breakthrough developed by James Strong in the late 1800's to identify each Hebrew word by a reference number to aid study and discussion of the text. Unfortunately, without computers, there were errors that have been recently revised and corrected by Kohlenberger and Swanson in The Strongest Strong's Concordance (John R. Kohlenberger III and James A. Swanson, Zondervan Publishing) in 2001. Versions printed without the correction have the original errors imbedded in them. Tools like Strongs are utilized by students to gain additional knowledge about the text, but the students are not necessarily looking to be a language scholar, but are rather looking for a more accurate, consistent and readable English bible version with a concordance for personal use.

Some Bible translations have a concordance, for example, the New International Version (NIV) and the NIV Exhaustive Conconcordance (Edward W. Goodrick & John R. Kolhenberger III, Zondervan, 1990) and The Strongest Strong's Exhaustive Concordance of the Bible based on the King James Version (KJV), 2001. The concordance allows the student to find significant inconsistencies in how words are translated, which is likely the result of varying scholarly opinions.

The student will find that very few words are CONSISTENTLY translated at the 100% level. If one were to perform a quick calculation, the quick calculation would arguably show that the Old Testament KJV overall is only 72% consistent apart from proper names, with the KJV New Testament a little better at 78%. These percentages suggest that only three of every four words are consistent. Therefore, if for everyday bible study-one in four words (outside of proper names) is not consistent in the text, then, it becomes difficult for the student to retain knowledge concerning the ancient root.

The inconsistencies found in the translations could possibly be attributed to the following:

a) Bible translations today are done by committee. The NIV, for example, was done with numerous scholars and editors, which means a lot of discussion and compromise. For key reference works in history, this methodology has been enhanced by commissioning small groups of experts to tackle translations. Translating and editing in small groups is fraught with a host of other issues. First of all, groups must compromise on a final text. Second, the translations do not have easily discernable miles for translation. The final reader has no idea what went into the process for every word in the text, and without utilizing extra resources cannot easily find out whether they would agree or not with the word choice.

b) The purpose of a translation is to transmit the essence of the total meaning. All of the different translations do this effectively—and in fact, forcing the word to be a single meaning across the board may be “too severe” in some cases as there are nuances of meaning in all languages. A new translation methodology for ancient text is needed that provides greater consistently. A more consistent translation methodology that utilizes predictable rules is needed for Bible translation and translation of other ancient text.

### BRIEF SUMMARY OF INVENTION

The invention is a method of translating ancient text which changes the way in which TRANSLATIONS are done and the EDITING of these key reference works, such as for example the Bible, Koran, Talmud, and the Bhagavad-Gita. Translation of a typical document from the original language to a different language can usually be performed by a single individual. However, for key reference works in history, such as the Bible, this methodology has been enhanced by commissioning small groups of experts to perform translations from ancient manuscripts written in ancient Hebrew or Greek. Translating and editing in small groups can be fraught with a host of issues. First of all, groups must compromise on a final text. Therefore, the translations may not have easily discernable rules for translation. The final reader has no idea what went into the process for every word in the text, and without utilizing extra resources cannot easily find out whether they would agree or not with the word choice.

The invention is a new method of translating, which is suggested for translations of ancient languages based upon new general rules for ancient language translation comprising the steps of: identifying every single core ancient root and associated ancient root family and correlating it to a translated single English root, with near 100% consistency, where any English word utilized for a specific ancient root family is only used once and every different ancient root uses a new English word, and where all related roots within a family derived from the same core ancient root utilize consistent English words to allow the reader to follow the core root. Another embodiment of the invention further comprises the steps of using words from the ancient language in the translated text where appropriate and in reverse, use modern English where appropriate. Yet another embodiment of the invention further comprises the steps of using only one English word for each ancient root and where two English words are required for a clear translation, the words are hyphenated to demonstrate to the reader of the translation that there is only one ancient root involved, and hyphenated, but one word is italicized, where the italicized word is for clarity only. Translation to a single English root, utilizing the above method, with near 100% consistency can be achieved for example for an ancient text like the Bible with greater than about 95% consistency.

These rules can apply to any translation from any language into any language. The clearly spelled out rules can allow anyone to understand and challenge the words selected and recommend improvements for editing purposes. Inputs for the translation and its editing can come from anyone, whether the individual is a scholar in the area of translation or an ordinary student of the ancient text such as the Bible. The translation with editing capability can be implemented on a wide area network (WAN) such as the worldwide web internet environment (Internet) and a world wide translation can be developed.

Implementation on a WAN virtually can assemble every expert around the world who is willing to participate ‘inside the room’. The end result can be the single best source reviewed by people around the world with their expertise in many areas. For example, someone who is an expert on winemaking (or any other topic), may easily recognize that a particular technical term like ‘lees’ (or any other technical term) is used incorrectly. The expert must pick a better word in accordance with the universal translation rules defined by the present invention. If the expert's chosen replacement word is in use, because of the rules of the present invention, then the expert must suggest another new word to substitute for that word as well. The suggestions MUST work for each and every use of the root and its related words in the text.

Therefore, yet another embodiment of the present invention including the editing method comprises the steps of: creating a compilation showing the choice of every word used in the translated text and an indication of the confidence in the word; creating a compilation showing the relationship between specific words and the core root in that language; providing a draft translation utilizing the core root translation rules; accessing the compilations and draft translation on a web site available for general comment from anyone in the world; and editing the translated text in accordance with the ancient roots translation on an on going basis.

This translation and editing method can result in the best and most consistent translations ever done, while continuously improving the translation with new information from fields such as archeology. The present ancient core root translation invention can be readily implemented as a software application utilizing software techniques well known to those skilled in the art. The software application can include a user interface that provides various search functions and other interface functions coupled with searchable documentation, such as for example Bible translations, including Strong's, KJV, NIV and other documents to assist in locating the core ancient root. Ultimately, new dictionaries and thesauruses for the ancient language will be natural by-products, as well as new software to aid in other translations of that language.

These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIGS. 1A-1B are tabular compilations of the ancient roots for the 100 highest used words in the Bible and the corresponding primary translation choice for the NIV, New American Standard Bible (NASB) and KJV Bible translation noting the consistency percentage;

FIGS. 2A-2B are tabular compilations of a given English translation root assigned referenced to multiple corresponding ancient roots in the family as referenced the Strong's reference number and referenced to the main root;

FIG. 3 is a flow diagram of the prior art method of translation;

FIGS. 4-5 are representative of the flow diagram for the present invention ancient root translation method;

FIG. 6 is a comparison of various Bible versions for the percent of Ancient words matched to English words by category of words;

FIG. 7 is a comparison of features for various Bible versions; and

FIG. 8A-8B is an index of places comparing the ARTB and KJV versions.

### DETAILED DESCRIPTION OF INVENTION

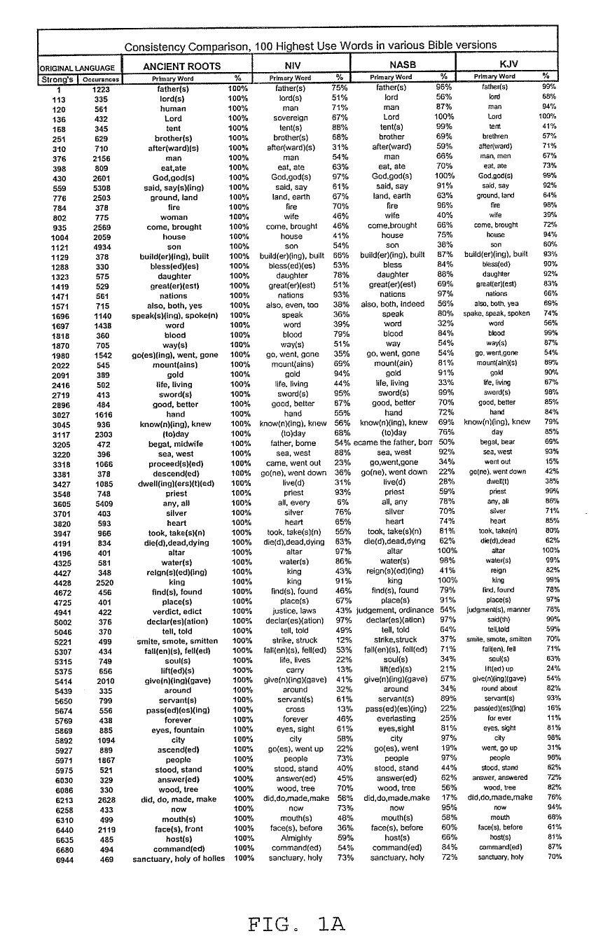

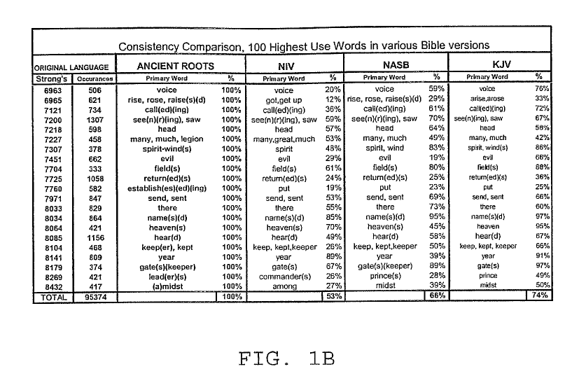

According to the embodiment(s) of the present invention, various views are illustrated in FIG. 1-7 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified. These examples are in English but apply to a second language.

One embodiment of the present invention comprising the steps of identifying every single core ancient root and associated ancient root family; and correlating the ancient root and ancient root family to a translated single English root, with near 100% consistency teaches a novel method for translation of ancient text.

The details of the invention and various embodiments can be better understood by referring to the figures of the drawing. Referring to FIGS. 1A-1C tabular compilations of the ancient roots for the 100 highest used words in the Bible and the corresponding primary translation choice for the NIV, NASB and KJV Bible translation noting the consistency percentage is shown. Upon examination one will find that very few words are consistently translated at the near 100% level. If one were to perform a quick calculation, the quick calculation would arguably show that the Old Testament KJV overall is only 72% consistent apart from proper names, with the KJV New Testament a little better at 78%. These percentages suggest that only three of every four words are consistent. This is why a concordance is usually utilized as a crutch for even more mature students. Therefore, if for everyday bible study—one in four words (outside of proper names) is not consistent in the text, then, it becomes difficult for the student to retain knowledge concerning the ancient root.

The table in FIGS. 1A-1C tabulate the top 100 Hebrew roots that occur in the Bible. These exclude numbers, proper names and pronouns/articles. These 100 words represent ¼ of the total words in the Bible. (These 100 are from a total of close to 8500 Hebrew words in all.). For each Bible version, tabulated are the Primary English word used, and then tabulated are the total number of times that English word was used and calculated a percentage consistency. At the bottom of the columns, the average value for the consistency of the word is listed. For the ANCIENT ROOTS™ Bible (Copyright ©2005 by Anna Frances Werner), it's 99.9%, for NIV, it's 52%, NASB 64% and KJV 73%. ANCIENT ROOTS™ is a trademark of Anna Frances Werner.

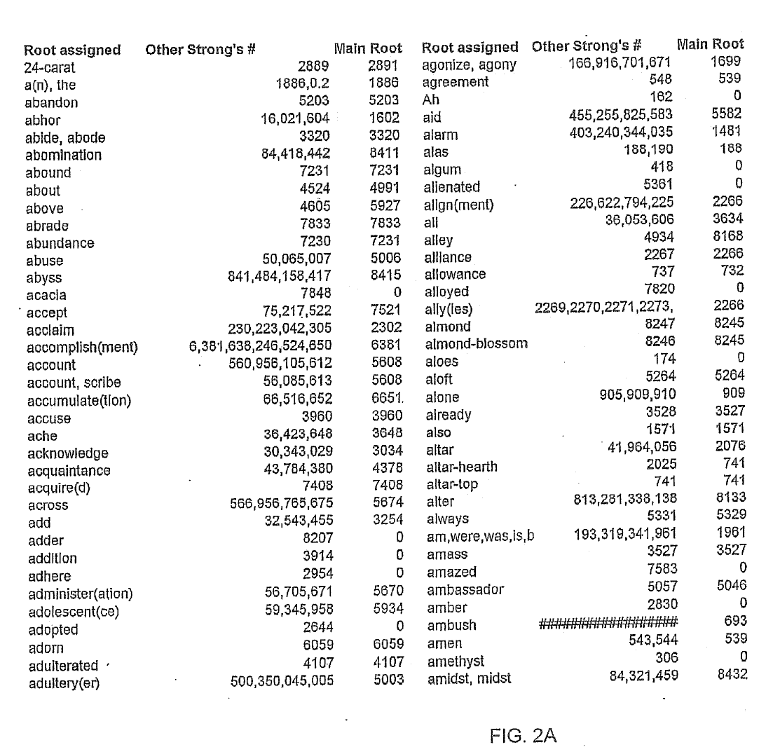

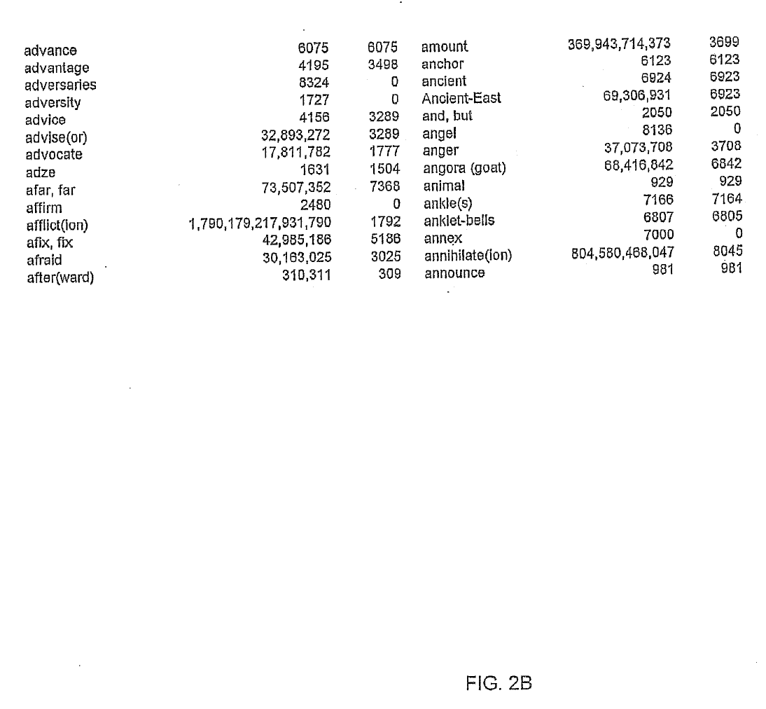

FIGS. 2A-2B are tabular compilations of a given English translation root assigned and referenced to multiple corresponding ancient roots in the family as referenced the Strong's reference number and referenced to the main root. This table provides a sampling of the translation results utilizing the present ancient roots translation invention.

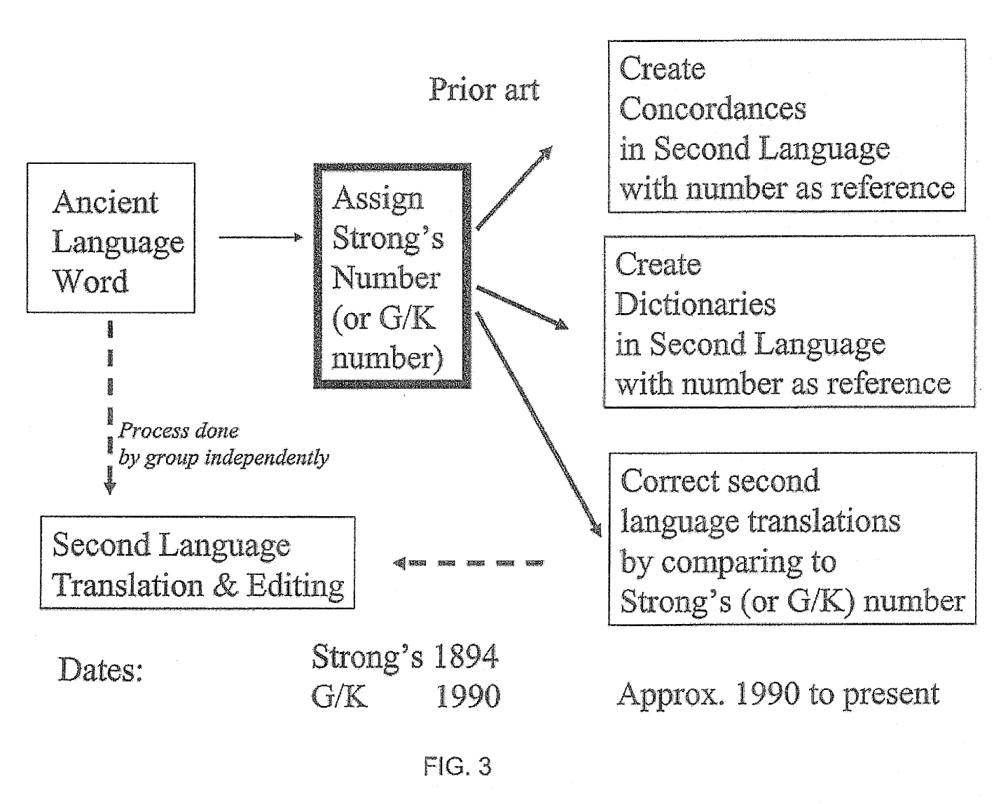

FIG. 3 is a flow diagram of the prior art method of translation. Bible translations today are generally done by committee, which is reflected in the flow diagram of FIG. 3. The NIV, for example, was done with numerous scholars and editors, which means a lot of discussion and compromise. For key reference works in history, this methodology has been enhanced by commissioning small groups of experts to tackle translations. Translating and editing in small groups is fraught with a host of other issues. First of all, groups must compromise on a final text. After the translating was complete, to help the reader, The Strongs or Goodrich/Kohlenberger reference was assigned individual words for lexical indexing to create concordance and dictionaries to aid the reader. So the translations do not have easily discernable rules for translation. The final reader has no idea what went into the process for every word in the text, and without utilizing extra resources cannot easily find out whether they would agree or not with the word choice. Also the aids that are generated, such as concordances and dictionaries were separate from the process of translation into a second language.

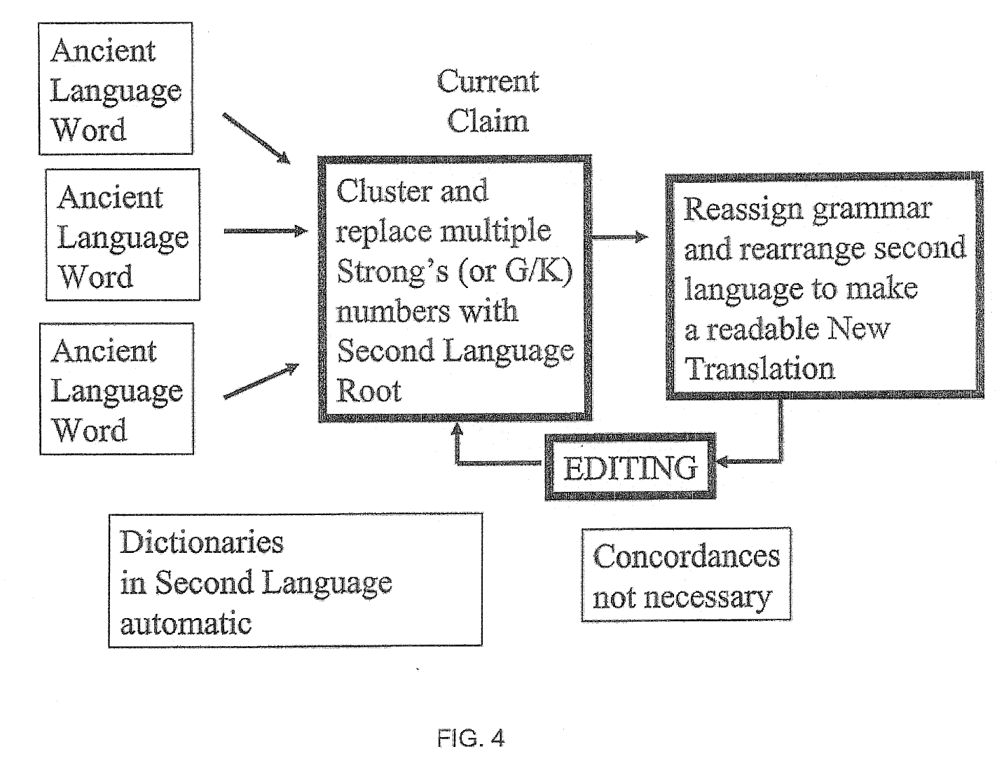

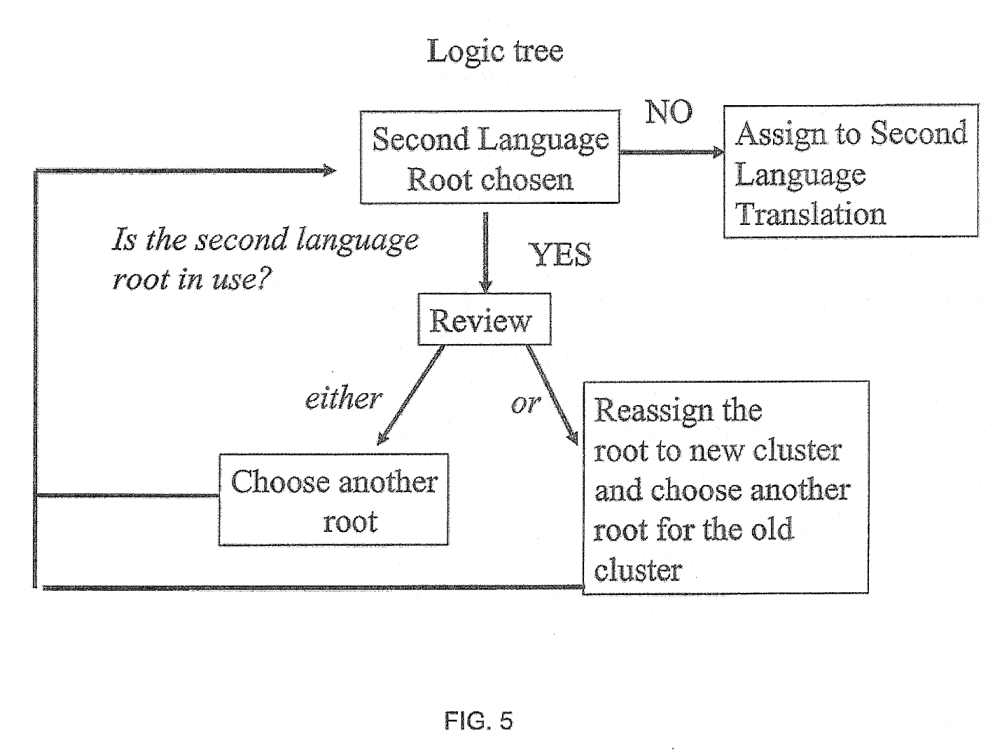

FIGS. 4-5 are representative of the flow diagram for the present invention ancient root translation method. FIG. 4 is representative of the top level flow for the Ancient Root Translation Method. The first step in the flow is a comprehensive examination of the ancient language such as Hebrew or Greek and grouping the words from the ancient language into families of related words creating what can be referred to as a ancient language word cluster. The ancient language word family or cluster are closely related terms having very similar or identical meanings. The family or cluster includes a main or primary ancient root and other secondary roots that have similar or identical meanings.

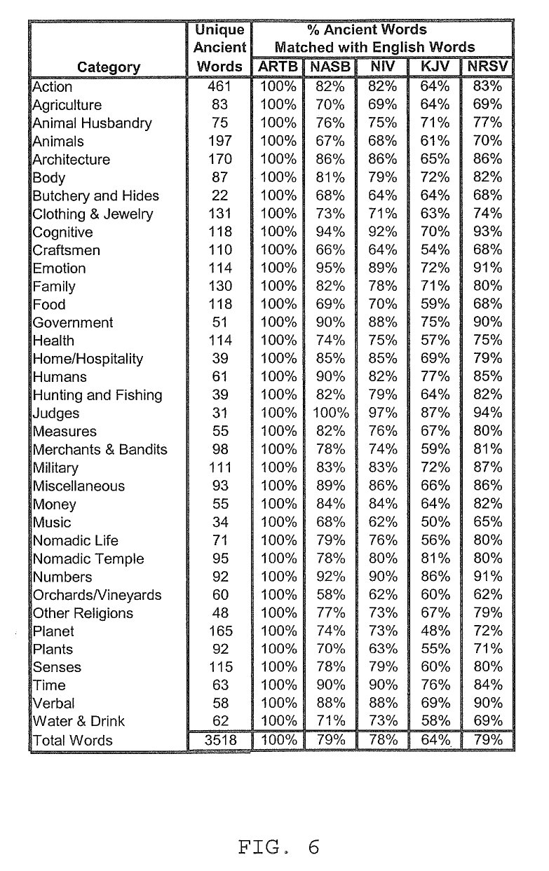

FIG. 6 shows a comparison of various Bible versions for the percent of Ancient words matched to English words by category. The table shows sample categories and the number of unique ancient words within the category and the percent of the ancient words matched consistently with an English translated root word. The percentages are shown for five bible translations including an ARTB translation, which utilized the translation method of the present invention.

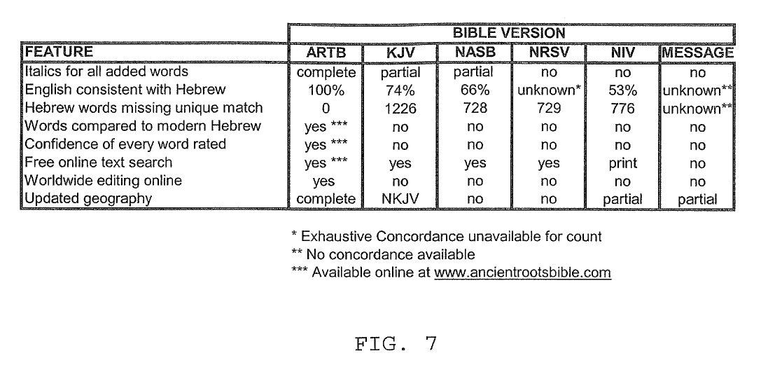

FIG. 7 shows a comparison of features for various Bible versions including the ARTB translation, which has all features.

A single second language root is assigned to that cluster without the use of a Strong's or Goodrich/Kohlenberger reference number. Therefore, wherever within the ancient text or manuscript one of the language words from the cluster appears, the second language group is reassigned within the translation.

The grammar can be rearranged and adjusted in the second language translation to make the new translation more readable. The process for selection of the single second language root assigned to the family or cluster is depicted in the flow diagram shown in FIGS. 4 and 5. After defining a cluster or family of ancient language root words, a single second language root is chosen and preliminarily assigned to the cluster or family. If the second language root is already in use then further review is required.

The translator must then examine the ancient roots further to determine if the second language root chosen is more appropriate for the present cluster or family for which it is already assigned or whether the second language root is more appropriate for the new cluster for which the translator is currently working. If the translator decides that the present assignment of the second language root is appropriate, then the translator must choose another second language translation root and repeat the same review process. If the translator decides to reassign the second language root chosen to the new cluster or family for which the translator is currently working, then the translator must choose another second language root for the cluster or family for which the root was previously assigned. Again, the process must be repeated. Once the translator selects a second language root that has not been previously assigned, then the second language root chosen is assigned as the second language translation root for the cluster or family for which the translator is currently working.

The following will describe specific translation examples. Again, this applies to any second language, but using English as an example. As indicated in the flow diagrams of FIGS. 4 and 5 every single Hebrew root is translated or correlated to a single English root. For example when examining the use of the second language word FATHER and how it is assigned to an ancient root, the present ancient root translation invention can be utilized to utilize the second language word Father with near 100% consistency. FATHER is a good example because it has the highest frequency usage as a second language English translation root in the KJV. Then the translator can follow the ancient root translation flow simply correct the lower frequency English words utilized in the KJV for the same ancient root to FATHER. That works well for FATHER (see FIG. 1A for the result).

However, when selecting a single second language translation word for over 3600 ancient roots that are less consistent, as you have with the ancient Hebrew old testament Bible, the process becomes more sizable. This is the reason for grouping ancient roots into families or clusters of closely related ancient roots and assigning a single second language translation root to the cluster or family. This is important because the second language may not nearly have 3600 roots available to assign. For example, examine Strong's #120 assigned to an ancient Hebrew root, which is commonly translated as MAN in the KJV. The problem arises because the second language English root word MAN was the highest frequency word not only for ancient root Strong's #120, but also for a lot more ancient word entries in the King James version.

Please examine the following table.

| | | | Ancient | | Primary word | | |
|---|---|---|---|---|---|---|---|
| | | | Root | | KJV & | | Modern |
| Strong | | # | Version | Root | frequency | | Hebrew |
| 120 | n | 376 | human | 119 | man | 94% | human |
| 376 | n | 2156 | man, men | 377 | man, men | 67% | man |
| 582 | n | 42 | mortal(s) | 605 | man, men | 93% | humans |
| 606 A | n | 25 | mortal(s) | 605 | man, men | 92% | humans |
| 1167 | n | 82 | master(s) | 1166 | man, men | 29% | husband |
| 1397 | n | 65 | fellow(s) | 1396 | man, men | 94% | man |
| 1399 | n | 1 | fellow(s) | 1396 | man | 100% | man |
| 1400 A | n | 21 | fellow(s) | 1396 | man, men | 86% | man |

Eight different ancient Hebrew roots have all been translated as MAN, but certainly the Ancient Hebrew wouldn't have had EIGHT different words mean the same thing. This problem is the reason for the second tenet of Ancient Roots methodology for developing a cluster or family of ancient roots and discerning the primary or main ancient root within the family. Therefore, any word utilized for a specific Hebrew root family is only used once, and every new root in Hebrew uses a new English word. Therefore, the translator must select a primary ancient root around which a family or cluster is established and assign a single second language root. For example the translator must decide which one of the eight roots to assign as MAN. ANCIENT ROOTS™ Concordance, (Copyright © 2005 by Anna Frances Werner).

At this point the translator must utilize various tools to pick the appropriate second language root. For example the Translator may make use of the Oxford English-Hebrew/Hebrew-English Dictionary (Kernerman Publishing Ltd. and Lonnie Kahn Publishing Ltd., 1994), which is for modern Hebrew. The Oxford reduces the list to four from the eight where the word MAN is utilized. Lower frequency words in the KJV were also a help. The Oxford and KJV agreed that 376 and 1397, 1399 and 1400 were MAN. 376 was the highest use with over 2000 references, so it was identified as the primary or main root and assigned MAN. See the diagram below.

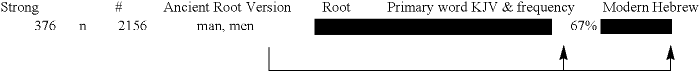

The translator then corrects 376 to MAN and 1397, 1399 and 1400 in the family or cluster to MAN. Then the translator must decide what to reassign to the other ancient roots or the other seven Strong's numbers. For example, what would be assigned to Strong's number 120? Again, the translator must utilize various tools to make a decision, for example, the notes in the Dictionary portion of the Strongest Strong's suggested the word HUMAN which matched the Oxford. Since the word HUMAN does not exist in the KJV for Strong number 120, but was suggested by the experts.

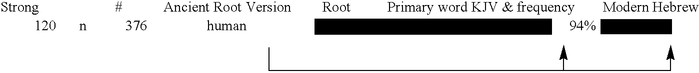

However, Since HUMAN wasn't in the KJV, it would mean changing all 376 entries for Strong's 120. It is this problem that make it evident that there aren't enough English language roots available for the number of Ancient Hebrew roots. There are 8600 Strong's entries in the Old Testament (with 2500 proper names) but there were no where near 3600 English words used in the King James Version, there were approximately 2400 words. Leaving out the Proper Names assists the translator to see the ‘connectedness’ of the language and it's flow. Another tool that assists the translator is again the Strongest Strong's. It suggests that certain words are related to each other. Therefore, if the grouping into families or clusters is utilized as defined by the present invention, then the translator does not need 3600 English words per se, but there might be a smaller total number of related words.

For example, see the following table for the ‘SERVE’ series:

| | | | | | Primary | | |
|---|---|---|---|---|---|---|---|
| | | | Ancient Root | | word KJV & | | Modern |
| Strong | | # | Version | Root | frequency | | Hebrew |
| 5647 | v | 288 | serve(s)(ed) | 5647 | serve(s)(ed) | 74% | slave |
| | | | (ing)(ant) | | (ing) | | |
| 5648 A | v | 28 | serve(r) | 5647 | made | 25% | slave |
| 5649 A | n | 7 | servant | 5647 | servant | 100% | slave |
| 5650 | n | 799 | servant(s) | 5647 | servant(s) | 93% | slave |
| 5652 | n | 1 | service | 5647 | works | 100% | slave |
| 5656 | n | 145 | service | 5647 | service | 65% | |
| 5657 | n | 2 | servants | 5647 | servants | 50% | |
| 5659 | n | 3 | servitude | 5647 | bondage | 100% | slavery |

Examining the parts of speech in the ancient language may assist in grouping words into a cluster or family. For example, if a translators examine ancient Hebrew in this manner they will find that the structure of the Ancient Hebrew/Aramaic is a language dominated by verbs and nouns (27% and 64% respectively) for a total greater than 90%. Adjectives, adverbs and miscellaneous parts of speech are <10% of the total. This is in contrast to English, which has a far greater use of adjectives. In the modern English language one can find that adjectives are used almost equally with nouns, with verbs at half the rate of them both. Our English language ‘describes’ while Ancient Hebrew and Aramaic ‘does’.

There are specific verbs in ancient Hebrew associated with specific nouns. For example, there are different verbs for playing different musical instruments like a shofar and trumpet, and different verbs for putting on clothing such as the ephod versus a cloak. Thus it makes sense to designate the verb (where available) as the Core Ancient Root. This examination of the parts of speech or categorization of words may result in different findings depending on the Ancient language or original language that is being translated. This finding leads to the third principle in the methodology. All related Hebrew and Aramaic words derived from the same Hebrew VERB (the CORE ANCIENT ROOT) are grouped into a family or cluster and then the translator selects and utilizes a consistent English word for each family to allow the reader to follow the core root. A noun can be used if no core verb is available.

However, this rule of utilizing the core verb or noun if no verb is available, can work well for ancient Hebrew, but another scheme can be chosen for a different original language depending on the structure of the given original language. The key is to examine the parts of speech in the original language and divide by categories and select the dominate category and alternative categories for determining your core root. The dominance of a category can be determined based on usage in common parlance or literature or by numbers of words in a given category or other reasonable metric.

Strong's provides limited guidance to words that are related to each other in the ancient Hebrew. Here's a taste of its entries:

| Strong | Related entries |
|---|---|
| 5647 | [4566,5650,5653,5656,5657,5659,5744, cf5648] |
| 5648 | [4567,5649,5673, cf5647] |
| 5649 | [5648, Cf5650] |
| 5650 | [5647,5651,5658,5660,5661,cf5649] |
| 5652 | [5647] |
| 5656 | [5647,cf5673] |
| 5657 | [5647] |
| 5659 | [5647] |

However, if you look at the Hebrew itself, all of the entries would have had the exact same spelling in ancient Hebrew, since there were no vowels: [symbol] . Thus, there is no guidance for selecting a CORE ROOT. However utilizing the present ancient core root invention and examining again the example for the SERVE series, it can be determined that 5647 is the verb in the series and is designated as the CORE ROOT for the series:

| | | | | | Primary | | |
|---|---|---|---|---|---|---|---|
| | | | Ancient Root | | word KJV & | | Modern |
| Strong | | # | Version | Root | frequency | | Hebrew |
| 5647 | v | 288 | serve(s)(ed) | 5647 | serve(s)(ed) | 74% | slave |
| | | | (ing)(ant) | | (ing) | | |
| 5648 A | v | 28 | serve(r) | 5647 | made | 25% | slave |
| 5649 A | n | 7 | servant | 5647 | servant | 100% | slave |
| 5650 | n | 799 | servant(s) | 5647 | servant(s) | 93% | slave |
| 5652 | n | 1 | service | 5647 | works | 100% | slave |
| 5656 | n | 145 | service | 5647 | service | 65% | |
| 5657 | n | 2 | servants | 5647 | servants | 50% | |
| 5659 | n | 3 | servitude | 5647 | bondage | 100% | slavery |

The dominant root makes the series crystal clear, one root can underly all the rest of the words. The related Aramaic verb 5648 (designated by ‘A’ column 2) can be generally translated MADE in the KJV—but in the Ancient Roots translation is SERVE. This allowed the translator to drive the compilation in a consistent, simple manner, and reduce the total number of English words needed. The translator doesn't have to select a new word for the Aramaic, but can be identical to the Hebrew. Numbers 5649 and 5650 are nouns translated as SERVANT (identical to KJV, but 5650 is only 93% accurate in KJV). The nouns 5652 and 5656 are SERVICE (65% accurate in KJV; 5652 is WORKS in KJV), and 5659 is SERVITUDE (BONDAGE in KJV). This is the origin of the title of this compilation “ANCIENT ROOTS”. Now any reader, scholarly in the original ancient language text or not can know that any time they see a related English words SERVE, SERVICE, SERVITUDE and SERVANT in the text, it is related to the core word 5647. The reader doesn't have to look it up as in the KJV when they see SERVE, MADE, WORKS, BONDAGE to guess whether it really is the same core root. Also note that most of this series is found as ‘SLAVE’ in modern Hebrew. Because it is certainly related, but not identical, it is colored green.

A primary example of the effectiveness of the above method as outlined is one of the worst cases in the King James Version—the English word DESTRUCTION. Even though it is only utilized 80+ times in the KJV, it is used over and over again to represents 30+ different Hebrew words. There is no way for the English reader to discern the different roots without a word-by-word study with a concordance. The above methodology closed the gap a bit on the English words needed. But it requires additional refining. In total, there are approximately 3600 CORE ROOTS in the Old Testament when the above method has been implemented, however, the King James Version only had 2400 English words reused multiple times. So over 1100 NEW English words had to be added to complete an Ancient Roots Bible translation. The NIV version is short approximately 800 words. For each core root, alternate Bible translations and Biblical dictionaries and other translator tools can be utilized and searched. For example, a translator can utilize Roget's 21^{st} Century Thesaurus, Second Edition, Barnes & Noble Books, 1999.

The translator must select a lot of “practical” everyday words in areas such as animal husbandry, plants of the bible, agriculture, military, architecture, and many other topics for example from Pliney the Elder around the time of Christ to deal with the plethora of words needed. However, depending upon the ancient text being translated and the time frame of the original autography or ancient manuscript, other references may be utilized. This can provide a reader of the Old Testament Bible, for example, which was not only the most important book in history for its spiritual content and most widely published, an incredibly complete view of nomadic life and civilization at that time because a greater meaning of the text can be gleaned by the reader.

For example, the Bible includes 6 different words for sheep, and 6 different words for goats, and 7 different words about lions, and some 25 weapons. How about a list of all the items for trade from around the world, or over 30 words on grapes and wine making? Refer to FIG. 6 which shows categories of Ancient words and the number of unique words per category and the percent words matched with English words compared by translation.

In the ancient core roots translated text the translator can choose to include these new words added above those seen in the KJV (1100) or NIV (800), with an underline in the ANCIENT ROOT™ Cross-Reference (Copyright© 2005 by Anna Frances Werner) and ANCIENT ROOT™ Thesaurus and Commentary (Copyright © 2005 by Anna Frances Werner) for easy reference.

| | | |
|---|---|---|
| descendant | 1247,1248 | 1248 |
| desecrate(ion) | 2610,2613 | 2610 |

The translator can then assemble a Thesaurus & Commentary when the Ancient Roots translation is complete. See below a sampling from the Thesaurus for an Ancient Roots translation and see words utilized for woodworking.

The left column lists by category all the core roots of the Ancient Roots version. The words not found in the King James Version are underlined.

| | |
|---|---|
| d. WOODWORKING | WOOD adze, awl, axe, bore, chop, clearcut, |
| GENERAL artisan, | compass (tool), cutter (tool), file (tool), hammer, |
| carve, craft(er), create, | hatchet, hew(n)(ers), lop, nails, peeled, plane, |
| design(er), graven, | timber, whet, woodwork. In a nomadic culture, |
| handiwork, hone, | WOODWORKING was one of the important |
| made, make(r), | specialty CRAFTS. Probably every family had |
| originate(al), network, | some of these tools to use to make HANDI- |
| new-creation, tool | WORK like tent-pegs and traps. |
| | Specialists later made parts for the temple |
| | interior. |

The right side is a very abbreviated description of the meaning and use of the words. The translator for example may determine the difference between a file and a cutter, and how timber is processed and the parts of a nomad tent. A reader can glance at the Thesaurus & Commentary generated from the ancient roots translation and the finding there from and obtain a quick ancient history tour.

The present invention presents a new category of translation, combining a bible version with a concordance, which allows the reader to touch the ancient language in a fresh way. For the first time, the reader with the aid of the Concordance can see all the background for the choice of each and every word utilized in the Ancient Roots, and know the source of the word and a degree of confidence in the word. For the first time, a near 100% CONSISTENT compilation is available where no footnote is required to let the reader know that SERVE in any verse is the same Hebrew root as SERVE in any other verse. For the first time, the corrected Strong's numbering is utilized in a text to give near 100% consistency.

A Thesaurus of all the words in the Old Testament can be compiled. An Ancient Roots translation version allows readers without any knowledge of Hebrew to ‘read’ Hebrew as if they knew the language. Too often, nuances of the language have been left out or changed to more modern terms. The narrative sections flow fairly easily, and frankly some of the prophetic sections are more difficult to understand. Once a translation has been completed utilizing the above method, the translation can be launched world wide over a WAN such as the internet. The translation can then be opened up to other translators across the English speaking world to search for and improve the words. Below is a sample text translated utilizing the ancient roots methodology.

Genesis 1

1 First, God created the heaven and the land.

2 The land was a chaotic abyss, with darkness over the face of the abyss. The Spirit-wind of God fluttered over the face of the waters.

3 God said, Light, be! And light was.

4 God saw the light was good. God separated between light and darkness.

5 God called the light Day, and the darkness He called Night. Evening was and morning was; day one.

Psalm 23 A Psalm of David

1 Yahweh feeds me; I want not.

2 He reclines me in settlements of grass, he herds me toward the waters of an oasis to

3 return my soul. He guides me in the tracks of righteousness because of his name.

4 I also go in the valley of the death-shadow, I fear no evil with you with me. Your staff and your stick, they comfort me.

5 You arrange a table to my face before my persecutors, you render my head with oil, with my cup brimming.

6 But good and mercy pursue me all the days of my life: and I dwell in the house of Yahweh for the length of my days.

Isaiah 53

1 Who believed our rumor? Toward whom is the arm of Yahweh revealed?

2 He ascended as a sucker to his face, a root from desert land. He had no form and no respect. We saw him with no desired appearance,

3. despised and ceased as a man, a man of pain and knowing sickness. From a covert our faces despised him and we considered him nothing.

4 Surely he lifted our sickness, and bore our pain. We considered him touched, smitten of God, and humbled.

5 But he was massacred for our transgressions, afflicted for our iniquities. The correction of our peace was over him. His stripes heal us.

In order to fine tune the translation method some minor editorial methodology can be utilized.

For example, the Ancient Core Roots Translation invention can use the ancient Hebrew words directly in the text where appropriate instead of grouping the ancient words in a cluster and assigning a second language translation root, and in reverse, uses modern English where appropriate. A few Hebrew words are familiar to the reader, like CHERUB and its plural CHERUBIM. However, other significant words in Hebrew like SHOFAR (ram's horn for jubilee), MENORA (candlestick in the tent of meeting), TORAH (the law), YAHWEH (God the Father's name) have been placed in the text. These words can be listed in the Concordance and Root Cross-Reference in RED:

| | | | | | | |
|---|---|---|---|---|---|---|
| 3742 | n | 91 | cherubim | 3745 | cherubim | 100% cherubim |

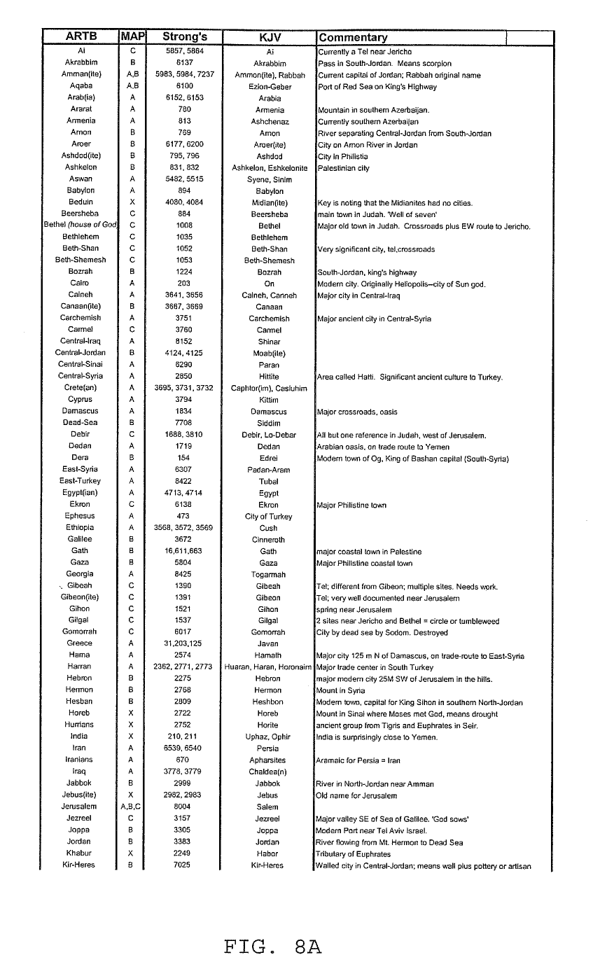

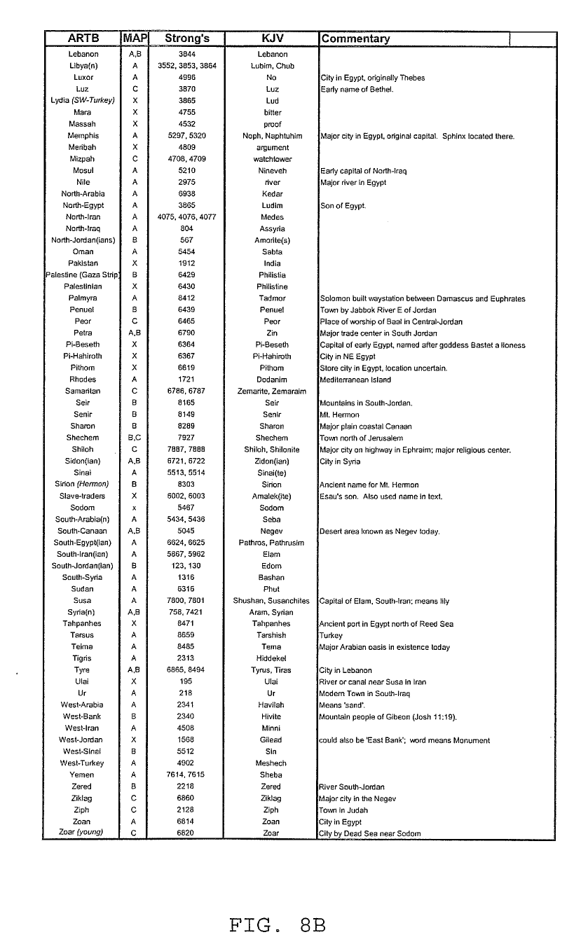

The other original Hebrew words in use in the KJV are: MYRRH, PHAROAH, SERAPHIM, TERAPHIM, SABBATH, NAZARITE, CAMEL, SELAH and SAPPHIRE as well as the specific weights and measures: MINA, SHEKEL, OMER, HIN, BATH, and LOG. The use of modern English makes sense particularly with names of countries and people that are more familiar to us, see FIGS. 8A and 8B. The KJV uses this technique, utilizing EGYPT rather than the Hebrew name of Mizraim. I've extended this to ETHIOPIA (Cush), GREECE (Javan), LIBYA (Put), SYRIA (Aram).

The basic rule of the present invention is only one English word is used for each root, however, many times two English words better describe one ancient core root. Where two are required, they are hyphenated to demonstrate to the reader that there is only one root involved. An example is word 6116, Solemn-Assembly in the Ancient Roots. In the KJV, the Hebrew root is communicated through two separate words. The casual reader would have no knowledge whether there are two underlying roots, one for SOLEMN and one for ASSEMBLY. Hyphenation can also be used when the second language translation root simply doesn't work in a given sentence grammatically or otherwise, but the second word that is not the second language root is italicized. This case generally only occurs with verbs, where the word simply doesn't work—like SLOTHFUL. There simply is no verb to match, so in the text it is recorded as “is-SLOTHFUL”.

Also, there are numerous instances in the Hebrew where a word or series of words are repeated for emphasis. In most translations, the words are amplified by additional English words like SURELY. Instead of introducing another word, these Hebrew duplications are identified with the mark ∥xx∥ to help the reader not assume a typographical error.

Jeremiah 5:11 For the house of Israel and the house of Judah ∥cheats∥ me! declares Yahweh.

The translator can also try to maintain the correct grammar form from the original ancient language. For example, If the word in Hebrew is a noun, the translator can keep it as a noun in the text throughout. Sometimes, the resulting language is “stiff” but the translator can error on the side of consistency rather than readability in some cases. Also, a resulting “stiff” passage may signal the translator that an incorrect Ancient Root may be in use.

There can be a few exception allowed in the basic method. For example, there are some cases where there can be more than one English word assigned to a single Hebrew root. They can be designated by an ‘a’ or ‘b’ next to the Strong's number. An example is:

| | | | | Primary | | |
|---|---|---|---|---|---|---|
| | | Ancient Root | | word KJV & | | Modern |
| Strong | # | Version | Root | frequency | | Hebrew |
| 8127 a | | ivory | 8150 | teeth | 18% | ivory |
| 8127 b | 55 | teeth, tooth | 8150 | teeth | 75% | teeth |

There is no doubt from other texts that the word TEETH, TOOTH is the root in Hebrew. However, we are familiar with the term IVORY as a specific designation for an elephant's tusk. Thus, the translator can choose to split the use of the word into an ‘a’ and ‘b’ portion to aid the reader's understanding of the text.

Finally, some words can be needed to help the meaning or flow of a sentence. These words added for that purpose can be italicized in the text. The ideal would be to have the final translated version with NO italics. These added words can include: IF, THEM, and IS, for example. The other usage is to highlight additional meaning for the reader—as in “menora (lampstand)” or the meaning of names as appropriate.

A Bible produced from the above translation method can produce a Bible translation having the following features, which can be referred to as an Ancient Roots Translation Bible (ARTB).

Italics can be used in the Ancient Roots Translinear Bible (ARTB) to clearly signal to the reader any extra words that are not in the original language. Any added noun, verb, adverb or adjective is in italics in the ARTB. This version can contain articles (a, an, and, the) and some minor prepositions (of, by) that are not italicized at this point.

Modern translations in contemporary English, such as the New International Version (NIV) and The Message, do not have italics, because they are designed to communicate the scripture, not focus on being exact. Both the New American Standard Version (NASB) and the King James Version (KJV) do have italics. However, there are thousands of words in both versions that are not italicized in the English, but should be. The New Revised Standard Version (NRSV) is considered more of a study bible, but it does not use italics. Only an examination of an Exhaustive Concordance can show you which ones are designated “NIH”—not in Hebrew.

You can do a quick test of your Bible version by examining Genesis 1:3. In most translations it says “God said, ‘Let there be light,’ and there was light.”. The three words let and there (twice) do not exist in Hebrew. The words should either be eliminated or in italics. The ARTB says “God said, ‘Light be!’ And light was.”

The ARTB minimizes extra words as much as possible. There are three cases where italics are used:

1) Some italics are included in parenthesis. These are notes inserted by the author to help the reader understand the meaning of the text. The author can choose to include it in the text rather than a footnote so the reader doesn't miss the significance.

Genesis 29:33
She conceived again and begot a son, saying, “When Yahweh heard of the hatred to me, he gave me this also, and called his name Simeon (hear).”

The Message has “God-heard” in parenthesis, but no italics. NIV has a footnote, and the remaining two have nothing.

2) By far the largest use of italics is the word ‘will/would’. The reason is that there is no designation of a future tense in Hebrew or Aramaic by a separate word. Author has chosen to italicize to show the reader it is not in the text even though it is implied. Both the KJV and NASB designate these as “NIH, not in Hebrew”, but do not italicize them in the text.

3) On a less frequent basis, but worth noting, is the need for italics in the midst of sentences. For example in Genesis 3:19, the text reads “You are dust, and you will return into dust.” None of the current references on Strong's numbers by the experts shows any verb for the first half of the sentence. There must be a verb for are—so either the sentence is structured wrong or there is an error in Strong's number designation. Hopefully, these “oddball” italics can be resolved by online discussion. Bible scholars are invited to review these and forward comments at www.ancientrootsbible.com.

The data for the charts as seen on FIGS. 1A and 1B and FIGS. 6 and 7 show ARTB to be 100% consistent, versus 74% for the KJV, 66% for the NASB and 52% for the NIV. That means that the ARTB uses the same English word for a given Hebrew or Aramaic word 100% of the time. The rest of the numbers are averages for the top 100 words for the Old Testament in all the bible translations, excluding proper names. These top 100 words represent one-fourth of all the words in the bible. Results for the New King James Version are expected to be in the same ballpark as the KJV reported here.

Data are presented in the Consistency Comparison table FIG. 1A. In the first column, the Strong's numbers for the Hebrew and Aramaic words are presented in ascending order. The data are based upon summaries of the individual exhaustive concordances for each version. The next column shows the total number of occurances in the Old Testament. The first number is Strong's #1, which occurs 1223 times. All of the versions utilize the word father as the main word. The KJV utilizes the word 99% of the time, the NASB 96% of the time, but the NIV only uses it 75% of the time.

If you glance down the column for the KJV, you'll see that there are only 2 words which are 100% consistent: Lord (Strong's 136) and altar (Strong's 4196). The NASB, which was designed to be more exact has 4 words which are 100% consistent: Lord, God (Strong's 430), altar and king (Strong's 4428). The NIV has zero words 100% consistent All 100 words of the ARTB are 100% consistent, and not just these 100 words but all the words.

The Message has no concordance to do this analysis. It is expected to be in the same neighborhood as the NIV. The NRSV has a concordance, but it's not exhaustive to be able to easily count the results. It is expected to be in the same neighborhood as the NASB. One other interesting note. The author performed a quick manual count on a few words from The Interlinear Bible. Based upon a very small sample, the consistency was approximately 80%, well below the mark of 100% consistent.

Most Christians know that in the New Testament, the Greek words agape (God's love) and phileo (brotherly love) are generally translated as love in English, even though there are two distinct Greek words. That is a very specific example where a distinct Greek word is missing a unique match in the English translation—the reader cannot discern between the two.

The main reason there is not a match between every Hebrew and English word is that most of the other bible versions reuse the same English words again and again. If you take a look at Strong's number 376 on the Consistency Comparison, you'll see that all versions use the word man. However, if you look at Strong's number 120, you'll see that the ARTB employs the word human, while the remainder of the versions reuse man. The ancient Hebrews had two very distinct words, so the ARTB keeps that distinction.

Within the top 100 words, you will find that the pattern of reusing words in other versions continues with the word go/went (Strong's 1980, 3381, 5927); and that the NIV also reuses father (Strong's 1, 3205) and life (Strong's 2416 and 5315). Not only do the other translations utilize many words for a single Hebrew root, they also utilize the same English word for many Hebrew roots, obscuring them in the text. The worst example in all the best selling bibles is the English word destruction. It is utilized again and again for over 30 different Hebrew/Aramaic roots.

The total number of unique Hebrew/Aramaic words missing a match with a unique English word in all other bible versions is staggering. In total, there are 8674 Strong's numbers in the Old Testament. Approximately 2400 of them are proper names and places. The remaining 6300 consolidate to approximately 3600 “core” words, because Strong's numbers separate related nouns and verbs.

The KJV is missing over 1200 unique English words to match unique Hebrew and Aramaic words. Later translations such as the NIV, the NASB and the NRSV added approximately 500 of these unique words to the text, but all are still missing over 700 unique English words to match the Hebrew and Aramaic.

The full detail can appear in a Cross Reference Index listing all of the 3600 core words in the ARTB. In the last 4 columns, the word is compared to each of the versions: KJV, NIV, NASB, and NRSV. A “no” in the column means the author could not locate an equivalent word. An equivalent word could be something like female donkey when the ARTB has female-ass. The NASB, NIV and NRSV are surprisingly similar in their word usage: these versions appear to have copied their word listing from each other. All are still missing over 700 unique matching words in English.

Every Strong's entry (excluding proper names and places) is compared to modern Hebrew. This feature became important as the author was searching for the 700 missing Hebrew words. Modern Hebrew has certainly evolved from biblical times, but it was an interesting comparison.

The inclusion of the modern Hebrew led to a very simple scoring system for each and every word. For example, you'll see that the Strong's word #1, father, is not only the highest use word in all bible versions, but also the same word in modern Hebrew. That type of “double confirmation” gives the highest score possible in rating the confidence of each and every word in the ARTB.

Significant bible translations have been done by convening a group of experts. No editing apart from typographical errors has occurred outside the group. ARTB is proposing a worldwide edit process to gain inputs from experts in many fields of expertise. In addition, the editing process is done according to the Ancient Roots® methodology. This is not a freeform methodology like Wikipedia, where any topic or entry is accepted. Rather, the editing is done from a PLATFORM BASE, where the initial document is already available. In addition, editing must be done by very specific rules.

The KJV began this technique centuries ago, employing the word “Egypt” rather than the Hebrew word “Mizraim”. It was the author's choice to consistently make ALL Hebrew/Aramaic places equivalent to modern places if they exist today. So the story of Jonah happens on his way to Mosul (Iraq), not Nineveh, and Goliath of Gath is a Palestinian, not a Philistine. The entire listing can be included in a Places Index, see FIGS. 8A and 8B. Places which have been destroyed, like Sodom and Babylon, are referred to by their previous name in the text and on maps.

Not quite. Effort has been made to match one English word with one Hebrew and Aramaic word. Every noun, verb, adverb, and adjective is translated exactly as one noun, verb, adverb or adjective. But it is not technically possible to do it for two important word categories: pronouns (I, me, he, she, etc.) and negative designations (no, not, never). Both ancient languages can compound them onto words in the text, either as prefix or a suffix. The English language does this in far fewer cases (like I'm and don't), and never does it for any verb besides generic verbs like am, is, and do. Hebrew and Aramaic do it for all verbs-so thoughts like ‘I saw’ or ‘saw me’ can also look like new compounded words like ‘Isaw’ or ‘sawme’ in these languages. Remember, Hebrew was one of the earliest alphabetic languages: thank goodness we've kept improving for simplicity!

A specific example is the root serve. It is represented in Hebrew by Strong's number 5647 (verb, serve), and two nouns: servant (5649) and service (5652 and 5656). The Aramaic has a Strong's number for the verb (serve, 5648) and noun (servant, 5639). So there are a total of 6 individual Strong's numbers which are of the same root. Because the ARTB utilizes only these three words (serve, servant, and service) to represent the root serve 100% of the time, you don't need a separate reference to tell you these words are related: the reader know automatically.
This new word translinear specifically describes an exact translation methodology:—
100% of the ancient words in any language matched 100% of the time to a word in a second language.
Additional words are kept to a minimum. Any additional words in the second language not in the original ancient language are italicized.
Any unusual features in the ancient are signalled to the reader by special punctuation. Examples in the ARTB are: Hyphenated words to show there is only one word in the ancient text; and double lines ∥ to show double use of word in ancient text.

The various ancient root translation examples shown above illustrate a novel method for translating ancient text. A user of the present invention may choose any of the above ancient root translation embodiments, or an equivalent thereof, depending upon the desired application. In this regard, it is recognized that various forms of the subject ancient roots translation invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A new method of translating ancient text comprising the steps of:
identifying every core ancient root of an ancient text and grouping each core ancient root in an associated ancient root family; and
correlating each ancient root and associated ancient root family to a translated second language root, and consistently utilizing each correlating translated second language root to translate the ancient text with near 100% consistency, where any second language word utilized for a specific ancient root family is only used once and every different ancient root grouped in a different family uses a different second language word, and matching each ancient root to a second language root.

2. The method as recited in claim 1, where the ancient root family includes a primary ancient root and other secondary roots that have similar meaning.

3. The method as recited in claim 2, where the step of correlating includes the steps of:
preliminarily assigning each translated second language root to each respective correlating ancient root and associated ancient root family if the second language root has not already been correlated to another previously correlated associated ancient root family;
determining if each translated second language root is more appropriate for the previously correlated associated ancient root family if the translated second language root has already been correlated to the previously associated ancient root family;
re-correlating each translated second language root if not more appropriate for the previously correlated ancient root family; and
finding a different translated second language root if it is more appropriate for the previously correlated associated ancient root family.

4. The method as recited in claim 3, where the step of grouping includes grouping each core ancient root in an associated ancient root family based on the part of speech and the dominant part of speech for the language of the ancient text.

5. The method as recited in claim 4, further comprising the step of:
defining a degree of confidence in the correlation of each translated second language root.

6. The method as recited in claim 5, further comprising the steps of:
identifying any extraneous words needed for comprehension of the text; and
utilizing two second language words that are hyphenated for comprehension where one of the words is identified in a printed translation.

7. The method as recited in claim 6, further comprising the steps of:
completing a draft translated text into the translated second language;
creating a compilation showing the choice of every translated second language root used in the draft translated text and an indication of the degree of confidence in each translated second language root;
creating a compilation showing the relationship between specific words and the core root in that language;
providing the draft translated text utilizing the core root translation rules to a web site;
accessing the compilations and draft translated text on the web site available for general comment; and
editing the translated text in accordance with the ancient roots translation rules on an on going basis.

8. The method as recited in claim 7, including the step of:
filtering out any edits that are not in accordance with the ancient root translation rules.

9. A new method of translating ancient text comprising the steps of:
identifying every core ancient root of an ancient text and grouping each core ancient root in an associated ancient root family; and
correlating each ancient root and associated ancient root family to a translated second language root, and utilizing the translated second language root to translate every occurrence in the ancient text of the correlating ancient root with near 100% consistency without the need to utilize a reference number lexical indexing system, where any second language word utilized for a specific ancient root family is only used once and every different ancient root grouped in a different family uses a different second language word, and where all related roots within a family derived from the same core ancient root utilize consistent second language words to allow the reader to follow the core root when reading an ancient text translated utilizing the second language root.

10. The method as recited in claim 9, where the ancient root family includes a primary ancient root and other secondary roots that have similar meaning.

11. The method as recited in claim 10, where the step of correlating includes the steps of:
preliminarily assigning each translated second language root to each respective correlating ancient root and associated ancient root family if the second language root has not already been correlated to another previously correlated associated ancient root family;
determining if each translated second language root is more appropriate for the previously correlated associated ancient root family if the translated second language root has already been correlated to the previously associated ancient root family;
re-correlating each translated second language root if not more appropriate for the previously correlated ancient root family; and
finding a different translated second language root if it is more appropriate for the previously correlated associated ancient root family.

12. The method as recited in claim 11, where the step of grouping includes grouping each core ancient root in an associated ancient root family based on the part of speech and the dominant part of speech for the language of the ancient text.

13. The method as recited in claim 12, further comprising the step of:
defining a degree of confidence in the correlation of each translated second language root.

14. The method as recited in claim 13, further comprising the steps of:
identifying any extraneous words needed for comprehension of the text;
utilizing two second language words that are hyphenated for comprehension where one of the words is identified in a printed translation; and
adding extraneous words to a final translated text for comprehension and clearly identifying the added extraneous word.

15. The method as recited in claim 14, further comprising the steps of:
completing a draft translated text into the translated second language;
creating a compilation showing the choice of every translated second language root used in the draft translated text and a confidence level in each translated second language root;
creating a compilation showing the relationship between specific words and the core root in the ancient language;
providing the draft translated text utilizing the core root translation rules to a web site;
accessing the compilations and draft translated text on the web site available for general comment; and
editing the translated text in accordance with the ancient roots translation rules.

16. The method as recited in claim 15, including the step of:
filtering out any edits that are not in accordance with the ancient root translation rules.

17. A new method of world wide editing applicable to the text comprising the steps of:
creating a text platform as a starting translation;
posting the starting translation on a website accessible via a wide area network;
providing access to the starting translation over the wide area network and allowing editing of the starting translation in accordance with certain ancient root translation rules comprising,
correlating each ancient root and associated ancient root family to a translated second language root, and utilizing the translated second language root to translate an ancient text with near 100% consistency without the need to utilize reference number lexical indexing system, where any second language word utilized for a specific ancient root family is only used once and every different ancient root grouped in a different family uses a different second language word, and where all related roots within a family derived from the same core ancient root utilize consistent second language words to allow the reader to follow the core root when reading an ancient text translated utilizing the second language root; and
editing the translated ancient text by selecting a more appropriate second language root for a selected ancient root family.

18. The method as recited in claim 17, where the ancient root family includes a primary ancient root and other secondary roots that have similar meaning.

19. The method as recited in claim 18, where the step of correlating includes the steps of:
preliminarily assigning each translated second language root to each respective correlating ancient root and associated ancient root family if the second language root has not already been correlated to another previously correlated associated ancient root family when editing the posted translation;
determining if each translated second language root is more appropriate for the previously correlated associated ancient root family if the translated second language root has already been correlated to the previously associated ancient root family;
re-correlating each translated second language root if not more appropriate for the previously correlated ancient root family; and
finding a different translated second language root if it is more appropriate for the previously correlated associated ancient root family.

20. The method as recited in claim 19, where the step of grouping includes grouping each core ancient root in an associated ancient root family based on the part of speech and the dominant part of speech for the language of the ancient text.

21. The method as recited in claim 20, further comprising the step of:
defining a degree of confidence in the correlation of each translated second language root.

22. The method as recited in claim 21, further comprising the steps of:
identifying any extraneous words needed for comprehension of the text; and
utilizing two second language words that are hyphenated for comprehension where one of the words is identified in a printed translation.

23. The method as recited in claim 22, further comprising the steps of:
completing a draft translated text into the translated second language;
creating a compilation showing the choice of every translated second language root used in the draft translated text and an indication of the confidence level in each translated second language root;
creating a compilation showing the relationship between specific words and the core root in that language;
providing the draft translation utilizing the core root translation rules to a web site;
accessing the compilations and draft translation on the web site available for general comment; and
editing the translated text in accordance with the ancient roots translation rules on an on going basis.

24. The method as recited in claim 23, including the step of:
filtering out any edits that are not in accordance with the ancient root translation rules.
